(19) United States
(12) Patent Application Publication
(10) Pub. No.: US 2006/0040245 A1
(43) Pub. Date: Feb. 23, 2006

(54) Interactive medical procedure training

(76) Inventors: Christopher Allen Airola, Seattle, WA (US); Peter Eli Gruenbaum, Seattle, WA (US); Timothy Randall Burnett, Bellingham, WA (US); Janet Marie Martinson, Bellingham, WA (US); David Feiner Willard Robison, Seattle, WA (US); Robert Marten Sweet, Bellevue, WA (US)

Correspondence Address: Mark S. Peloquin;PELOQUIN, PLLC, Suite 4100, 800 Fifth Avenue, Seattle, WA, 98104-3100, US

(21) Appl. No.: 10/923,353

(22) Filed: Aug. 20, 2004

(51) Int. Cl. G09B 19/00; G09B 23/28

(52) U.S. Cl. 434/262

(57) ABSTRACT

Apparatuses and methods are described that provide for selecting an actor to participate in an interactive simulation of a medical procedure within a graphical user interface. A medical instrument is identified that is to be used by the actor and an association is indicated between the medical instrument and the actor. A user plays the role of the actor.

### BACKGROUND OF THE INVENTION

1. Field of Invention

The invention relates generally to medical training, and more specifically to methods and apparatuses for providing an interactive medical procedure environment.

2. Art Background

People, such as physicians, veterinarians, assistants, nurses, etc., who are engaged in the dispensation of medical services to living beings require specialized training in existing and newly developed medical procedures in order to gain and to retain the skill required to perform the medical procedures competently.

Following medical school, a new physician (an intern) will participate during a medical procedure, such as a surgery in an operating room, as an observer or a minimal participant, while an experienced physician(s) operates on a living being such as a person or an animal. Such “live” opportunities to observe and to participate in the medical procedure are limited and the number of people that can actually be in an operating room at one time is limited. In order to become proficient in a medical procedure, repetition of the experience is necessary for most people to become competent performers of the procedure. These limited opportunities for new physicians to participate during “live” medical procedures may present a problem.

Currently, there are limited opportunities for the new physician to “fail” during a medical procedure. Simulators have been developed for use with medical procedures with the goal of providing a training environment to the new physician or medical professional such that failure does not produce a catastrophic result. Simulators have involved specialized equipment, such as a special purpose manikin or device that is used in conjunction with the simulator. Simulators are expensive, and as such, are not deployed in such quantities that would enable any medical professional to practice a medical procedure at will, this may present a problem. In addition to the psychomotor and visual spatial skills which are involved with performing surgery, much of what is learned of a surgical procedure is actually cognitive in nature. Medical professionals performing procedures, much like a musician or an athlete repeatedly mentally rehearse their “routine” prior to their performance. Various medical atlases such as the publication from W. B. Saunders Company, i.e., Atlas of Pediatric Urological Surgery, Atlas of UroSurgical Anatomy, etc. contain black and white pencil drawings and enjoy wide distribution. Currently such atlases, in combination with videos and/or old operative reports, aid in this mental preparation. These atlases and others like them provide a one dimensional learning format, the printed page. Additionally, atlases/operative reports do not provide a life like representation of the living being in the mind of the reader and videos fail to provide objective feedback as to the user's ability to understand the information it intends to convey. A physician reads the atlas or operative report and may be confronted with a different mental image or situation when observing or performing a “live” medical procedure. This may present a problem.

One of the most advanced skills obtained during the acquisition of procedural mastery is learning how to effectively use an assistant. Every time a new member of the team is introduced in practice, this ability is tested and most often occurs on an actual patient. The existing preparatory tools, mentioned above, do not actually train or test the user's ability in this domain. This may present a problem.

Experienced physicians or veterinarians can have medical practices that require them to perform certain medical procedures infrequently. One example of a need to perform medical procedures on an infrequent basis is the battle field environment. The battlefield environment requires medical professionals to perform any number of varied and different medical procedures, such as surgeries rarely encountered in civilian practice of medicine. In such cases, the medical professional resorts to the atlases, videos, old operative reports or consultations with a remote subject matter expert to review the steps of the medical procedure of interest. Such an approach may present a problem.

New medical procedures originate at certain times and in certain places, and are not easily communicated to the group of interested medical professionals such that the group can become proficient in the new medical procedure. Problems with exposure to new medical procedures are especially acute with medical professionals who practice in rural or remote areas. Though strongly encouraged by the Accreditation Council for Graduate Medical Education (ACGME), currently there are no objective measures to insure these new procedures are truly understood prior to these skills being practiced on patients short of mentorship.

Practicing physicians attend continuing medical education (CME) to fulfill the requirements of certifying agencies. Such CME education is provided in a variety of formats such as courses attended in person, home study, etc. Courses attended in person where the attendees practice on simulators or participate in labs conducted with the use of animals or formerly live beings provides a limited number of opportunities for the group of possible attendees and these opportunities are costly, this may present a problem. In the home study format of CME delivery, verification that the medical professional actually participated in the CME is lacking. This may present a problem.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1A depicts a flow diagram depicting an embodiment of the invention.

FIG. 1B illustrates a flow diagram for an interactive medical procedure according to one embodiment of the invention.

FIG. 1C illustrates types of feedback provided to the user according to one embodiment of the invention.

FIG. 2 depicts testing according to one embodiment of the invention.

FIG. 3A depicts an arrangement of structures according to one embodiment of the invention.

FIG. 3B illustrates a main screen of a graphical user interface according to one embodiment of the invention.

FIG. 3C illustrates a patient history according to one embodiment of the invention.

FIG. 4A depicts a graphical user interface according to one embodiment of the invention.

FIG. 4B illustrates a preoperative screen according to an embodiment of the invention.

FIG. 5A illustrates a part of a medical procedure according to one embodiment of the invention.

FIG. 5B is a schematic illustrating a part of a medical procedure according to one embodiment of the invention.

FIG. 5C is a schematic illustrating a series of user interactions according to one embodiment of the invention.

FIG. 6 illustrates an association of an actor and a medical instrument according to one embodiment of the invention.

FIG. 7 illustrates another association of an actor and a medical instrument according to one embodiment of the invention.

FIG. 8 shows a test of a user action according to one embodiment of the invention.

FIG. 9 shows another test of a user action according to one embodiment of the invention.

FIG. 10 illustrates a frame of a video sequence according to one embodiment of the invention.

FIG. 11 illustrates an example of feedback provided to a user following an interactive training session, according to one embodiment of the invention.

FIG. 12 illustrates an example of score information provided to a user according to one embodiment of the invention

FIG. 13 illustrates a block diagram of a computer system in which embodiments of the present invention may be used.

FIG. 14 illustrates a network environment in which embodiments of the present invention may be implemented.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description does not limit the scope of the invention, as the scope of the invention is defined only by the appended claims.

Apparatuses and methods are disclosed that create an interactive medical procedure training environment for a user. A user includes but is not limited to physicians, veterinarians, assistants, nurses, etc. A user need not be a medical professional. Various terms are used to refer to medical professionals throughout this description, such as doctor, surgeon, physician, assistant, nurse, etc. No limitation is implied by the use of one term in place of another term and all such terms are only used for the purpose of illustration. Typical computer systems, such as those containing an information display, input/output devices, etc. together with information provided by relevant medical experts, and video of actual procedures are used to provide the interactive training environment utilizing a graphical user interface.

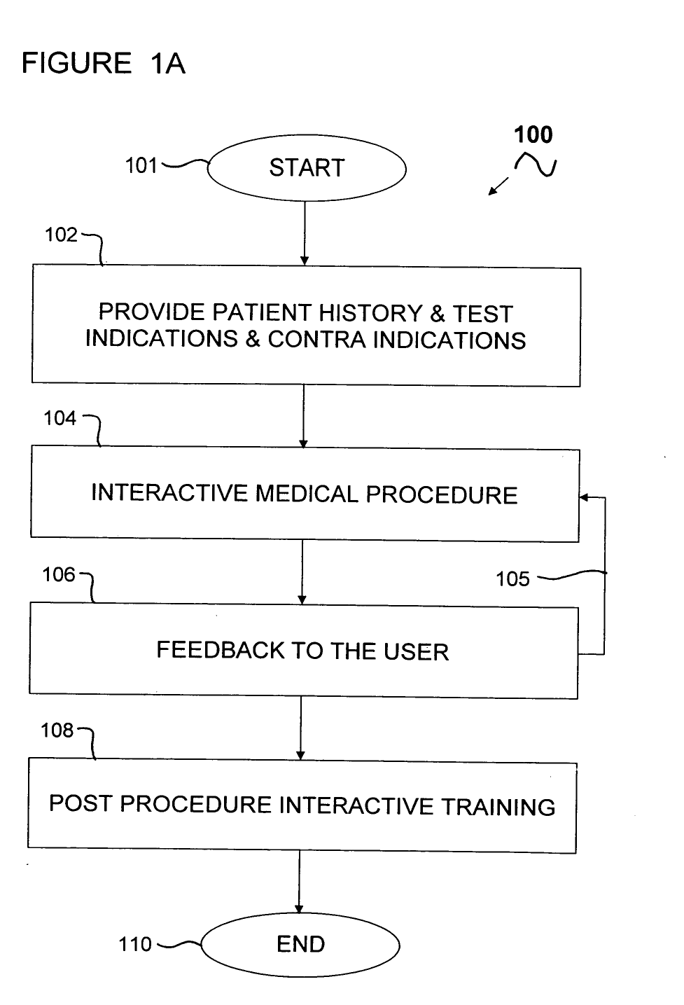

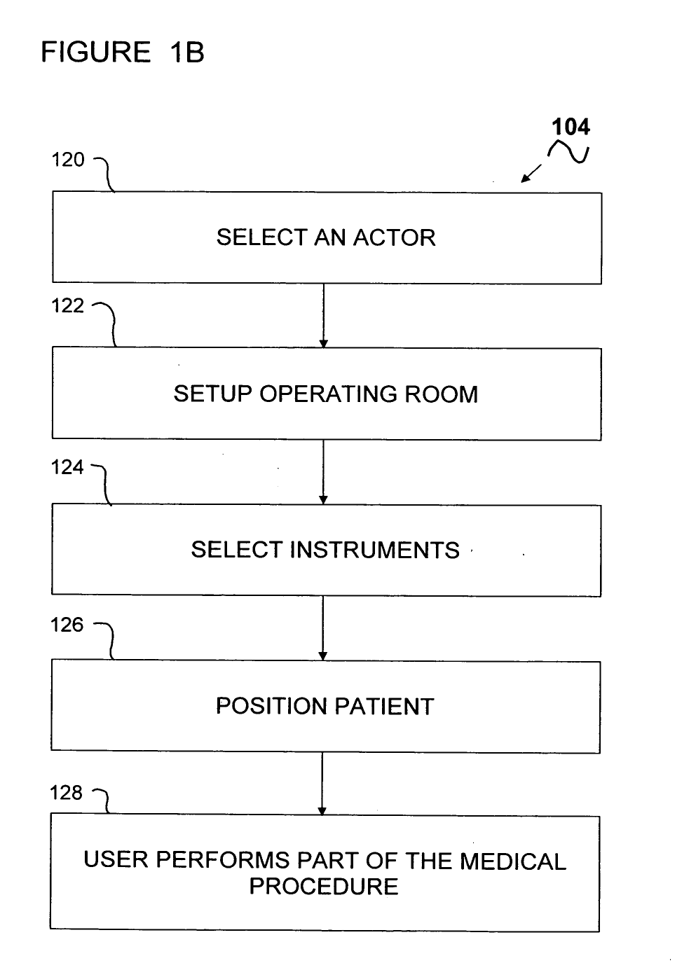

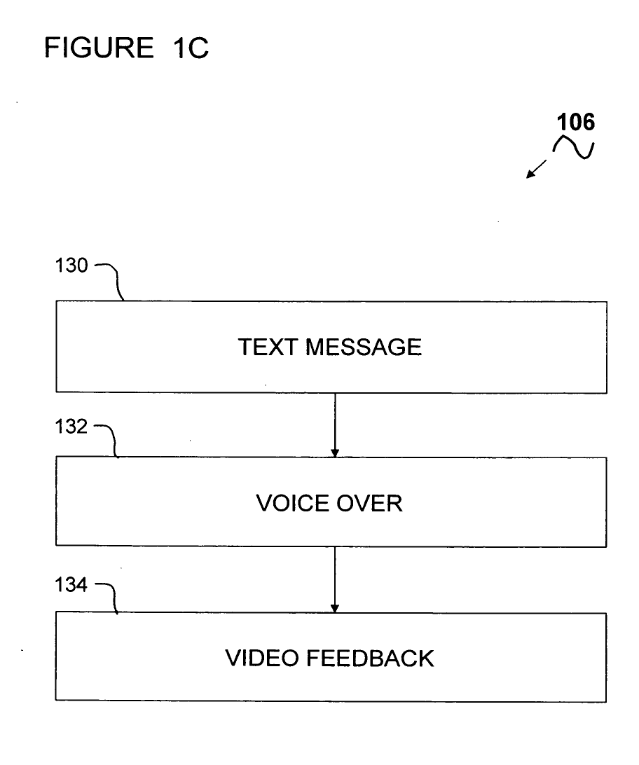

FIG. 1A depicts, generally at 100, a flow diagram depicting an embodiment of the invention. With reference to FIG. 1A, the process commences at block 101 when a user selects a particular medical procedure for the interactive training session. Selection by the user is accomplished in various ways, for example by using a pointing device such as a mouse or a stylus to select a menu item (selection of the medical procedure from a list of available procedures), or by other methods, such as by voice recognition. Any medical procedure can be the subject of the interactive training session; embodiments of the invention are not limited to a particular selection of a medical procedure. The subject of a medical procedure is any type of living being, such a person or an animal. At block 102, a relevant medical history is provided for a living being. The medical history can include, in various embodiments, a written medical record for the living being, such as a summary of the relevant facts that pertain to the condition(s) precipitating the need for the medical procedure. Testing of the indications in support of the medical procedure as well as the contraindications pertaining to the medical procedure can be tested at block 102 as well. At block 104 the user participates in the medical procedure by receiving instructions from the interactive environment as well as taking action which is analyzed by the interactive environment. At block 106, feedback is provided to the user based on the actions that the user takes at block 104. In a practice mode of the interactive environment, successive feedback is given to the user based on successive actions taken by the user by loop 105. At block 108 the user can participate in post procedure interactive training. The user's performance during the interactive training session can be tested in various embodiments and a score representing a result of such a test can be reported back to the user. The interactive training session ends at block 110.

“Medical procedure” as used herein is afforded broad meaning to encompass any medical procedure that is executed by a user. Some examples of the categories of medical procedures in which embodiments of the present invention can be applied are, but are not limited to, open surgery, endoscopic surgery, laparoscopic surgery, microsurgery, Seldinger technique, extracorporeal procedures, emergency medical procedures, etc.

FIG. 1B illustrates, generally at 104, a flow diagram for an interactive medical procedure according to one embodiment of the invention. With reference to FIG. 1B, user interaction begins with a user selecting an actor from a group of potential actors. A group of potential actors can be a group containing only one actor or a plurality of actors. One example of a group of potential actors is a group containing a physician and an assistant; another example is a group that contains several surgeons and several assistants. A correct selection of actors is configured for a medical procedure according to a format(s) recommended by a medical expert(s) who is consulted in order to create the content for the interactive training environment. Over time, as medical procedures evolve, the recommended selection of actors for a given medical procedure may change according to the teachings put forth by the medical experts, subject matter experts, as referred to herein. The user plays the role of the actor within the interactive training environment, performing acts that an actor, such as the lead medical professional (surgeon in this case) performs during the execution of an actual medical procedure.

At block 122 the operating room is setup. Setup of the operating room proceeds consistent with the requirements of a given medical procedure. For example, in one embodiment the user places the actors selected at block 120 in a particular location relative to a patient in the operating room. As is known to those of skill in the art, the location of the actors is determined by the role that the actor will play during the medical procedure. For example, in one embodiment, a surgeon will be positioned to one side of the patient and an assistant will be positioned to the right side of the surgeon. Due to particular facts and complications attendant upon a medical procedure, the assistant may be positioned to the left of the surgeon or on the other side of the patient relative to the surgeon. In various embodiments, the position of the lights and other pertinent equipment is also tested.

At block 124, the user playing the role of the actor, selects one or more instruments that will be needed during the medical procedure. In one embodiment, the instruments are selected from a back table to be placed on a Mayo stand. As those of skill in the art know, the Mayo stand contains the suite of instruments that are anticipated to be needed, most commonly, during a particular procedure.

At block 126, the user positions the patient for the beginning of the medical procedure. Positioning and preparing the patient is accomplished by selecting the position (i.e. supine, prone, dorsal lithotomy, etc.), appropriately padding the patient on points of pressure to prevent injury, and tilting or lifting the operating table, such that the user (playing the role of the surgeon) has an optimal view of the area of the patient where the medical procedure will occur.

At block 128, the user performs a part of the medical procedure by selecting an actor and then selecting that actor to use a medical instrument from the instruments selected previously and then performs the part of the medical procedure with the medical instrument, utilizing the graphical user interface. Performing part of the medical procedure, involves in one embodiment selecting a medical instrument such as a pair of forceps and pointing to a region on the information display where an image of the patient is displayed. The image of the patient is an actual digital image of a living being such as a human patient or animal. In one embodiment, the image is an extracorporeal view and in another embodiment, the image is of an open area of the patient's anatomy, such as the views shown in the figures below. The user points to the correct area on the digital image and then performs an action that is relevant to the part of the medical procedure being performed.

In one embodiment, a plurality of users perform a medical procedure in concert with each other similar to the way a medical procedure proceeds with the surgeon performing certain parts of the medical procedure and an assistant performing other parts or the two collaborate on the same part.

Medical procedures can be divided into a series of parts that follow in chronological order to change the state of the living being. For the purpose of this detailed description of embodiments of the invention, a medical procedure is described as a series of steps, where a step is made up of a series of substeps or moves. Other terminology can be applied, in place of step and move, no limitation is implied by the use of step and move, such terminology is used for the purpose of illustration only.

FIG. 1C illustrates, generally at 106, types of feedback provided to the user according to one embodiment of the invention. With reference to FIG. 1C, block 130 represents feedback in the form of text communication imparted to the user of the graphical user interface of the interactive training environment. Examples of feedback according to block 130 are described further in the figures that follow. Block 132 indicates feedback to the user in the form of audio feedback from a subject matter expert. Block 134 indicates video feedback related to a part of or a whole medical procedure. In one embodiment, following an action by a user, such as identification of a location on a digital image of a patient where an incision is to be made with a medical instrument, a video of that portion of the medical procedure runs within a window of the interactive training environment; thereby, allowing the user to see an actual recorded demonstration of the portion of the medical procedure. The audio feedback, block 132, plays as a voice over the video segment to provide the user with a narration of a properly executed portion of the medical procedure. In one embodiment, the entire medical procedure plays as a full motion video with voice-over narration by a subject-mater expert (SME).

In various embodiments, feedback to the user occurs upon request by the user in the form of a hint that can be communicated via text, audio, or video. Hints are described more fully below in conjunction with the figures that follow.

In various embodiments, feedback to a user is in the form of an error message. An error message can be communicated by a display of text, an audio communication, or a video simulation of what would occur based on an action that a user chooses. In one embodiment, color is used to display an error message, such as red.

In one embodiment, a practice mode of operation can be selected for an interactive training environment. The practice mode provides a user with feedback, such as notice of an error made, suggested alternatives, hints, consequences of actions taken, etc.

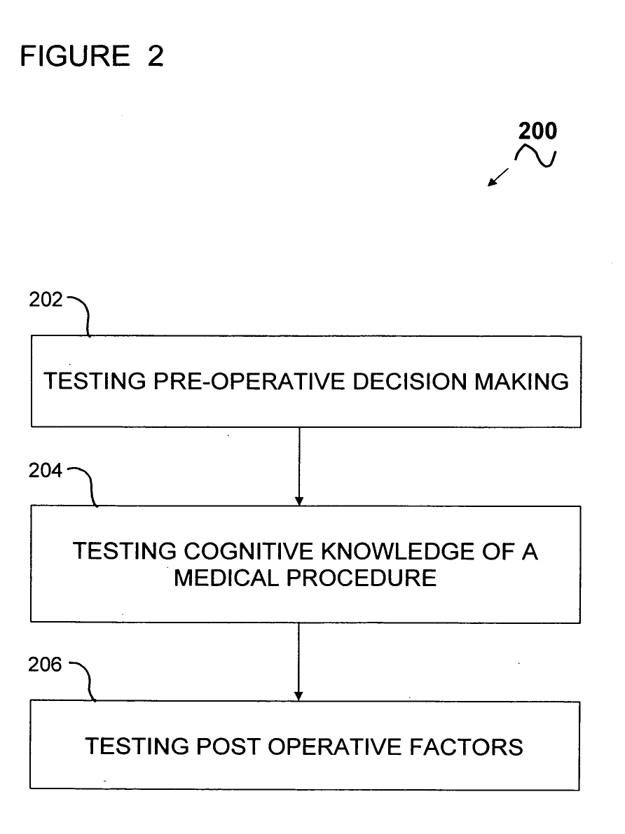

FIG. 2 depicts, generally at 200, testing according to one embodiment of the invention. With reference to FIG. 2, a user interacts with a graphical user interface by performing actions that register a result by the graphical user interface within the interactive training environment. Such results are analyzed against predefined values to determine a score for the user's action. Testing a user's responses can be performed at various levels within the interactive training environment. For example, in one embodiment, testing the user's actions following communication of the medical history, indications for surgery and contraindications for surgery are performed at block 202 to produce a score. Testing is performed in a variety of ways, such as but not limited to using a multiple choice question, utilizing voice recognition to ascertain a user's reply, etc. In another embodiment, testing is directed to a user's interpretation of various pre-operative labs, studies, etc.

In one embodiment, the user's actions are tested throughout the medical procedure at block 204. In another embodiment, the user's actions are not tested. In one embodiment; the user performs the medical procedure or a part of the medical procedure in a repetitive fashion to reinforce that part of the medical procedure in the user's mind. In another embodiment, the user performs the entire medical procedure from the first part to the last part without testing. In various embodiments, a user's cognitive knowledge of a medical procedure is tested, which includes but is not limited to knowledge of the parts of the medical procedure, ability to use an assistant(s), etc.

At block 206, post operative factors are tested, such as but not limited to complications, diagnostic dilemmas, case management, pathology, etc. In one or more embodiments, a score is produced from the testing. In various embodiments, scores are accumulated through the user's interaction with the graphical user interface and are used in various ways as described below in conjunction with the figures that follow.

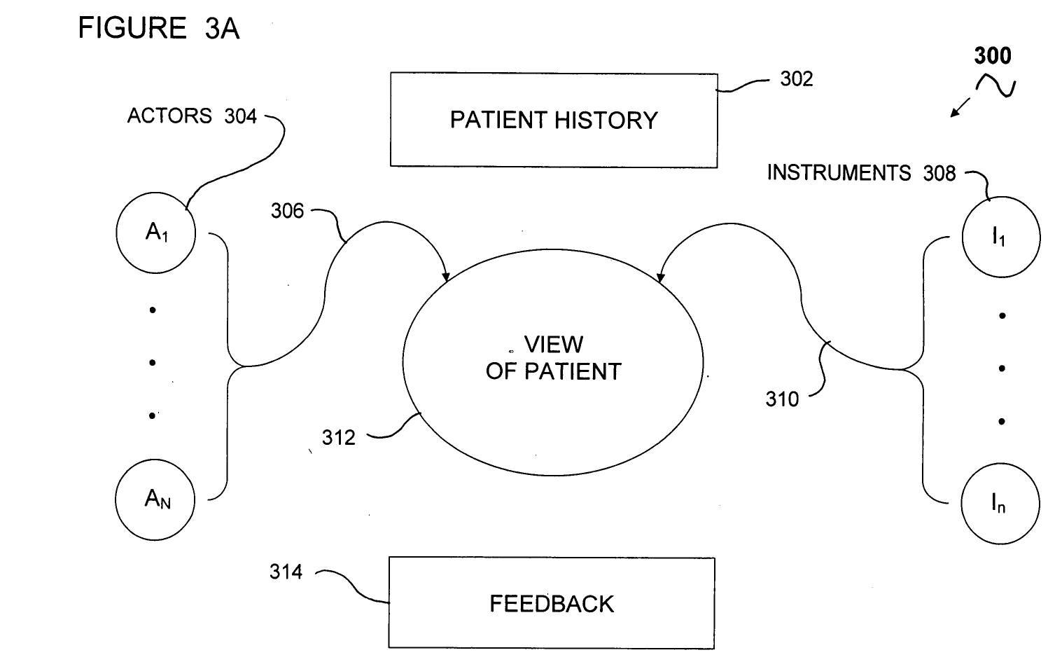

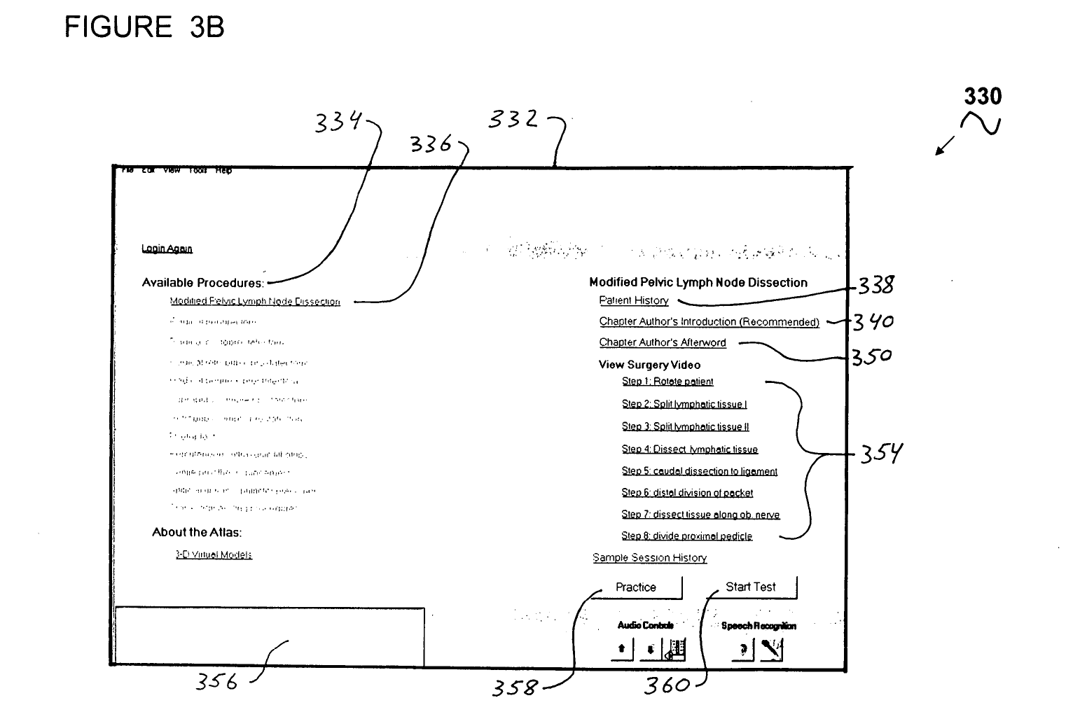

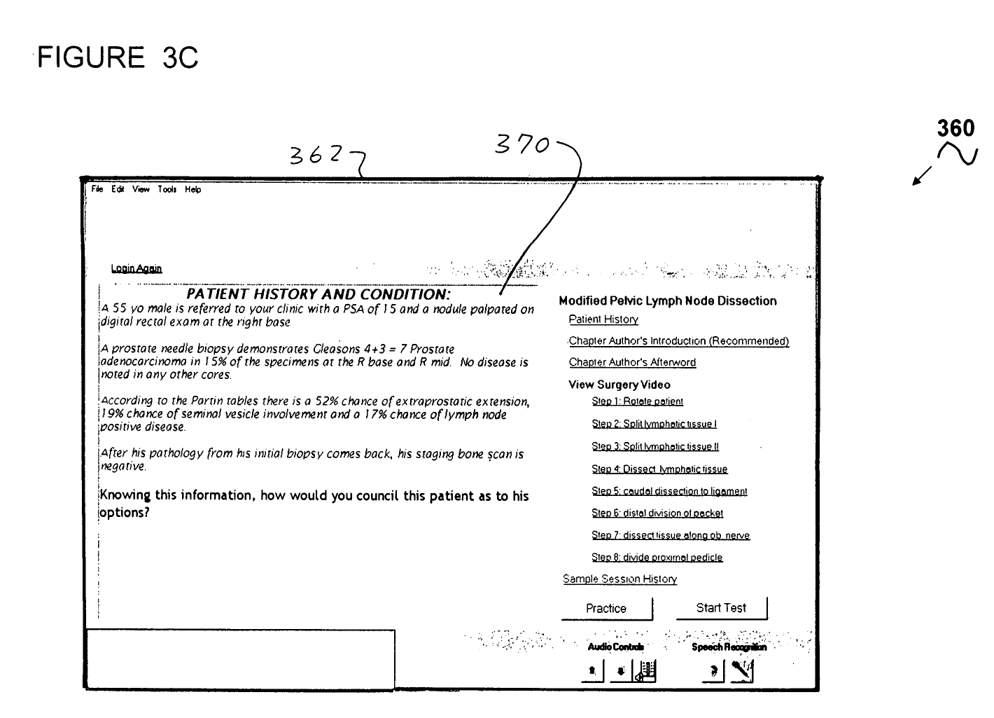

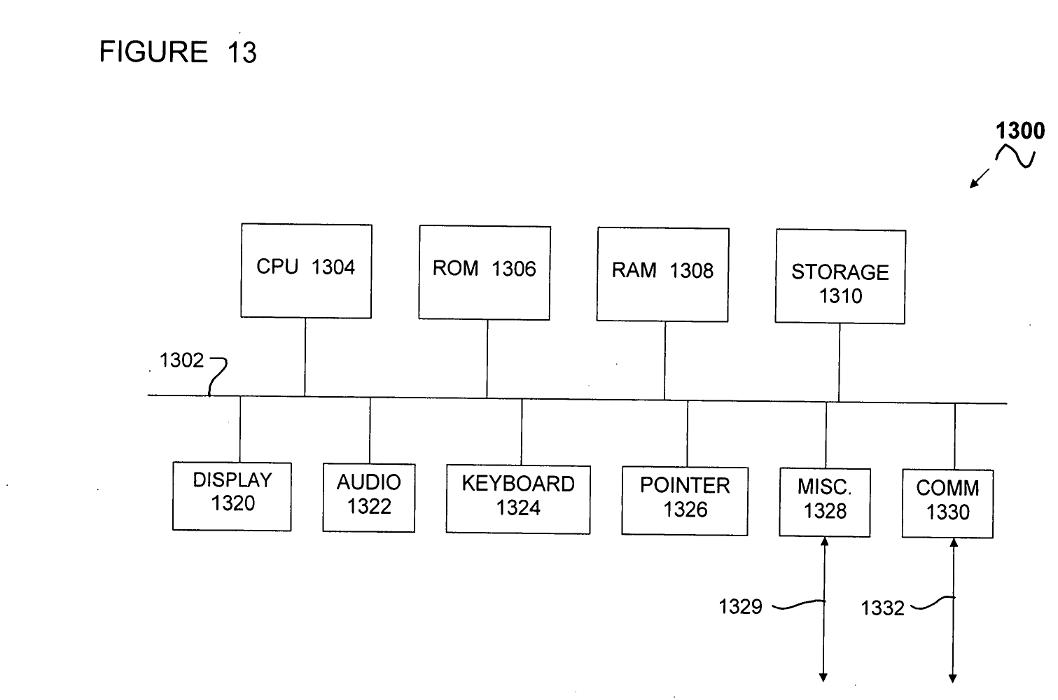

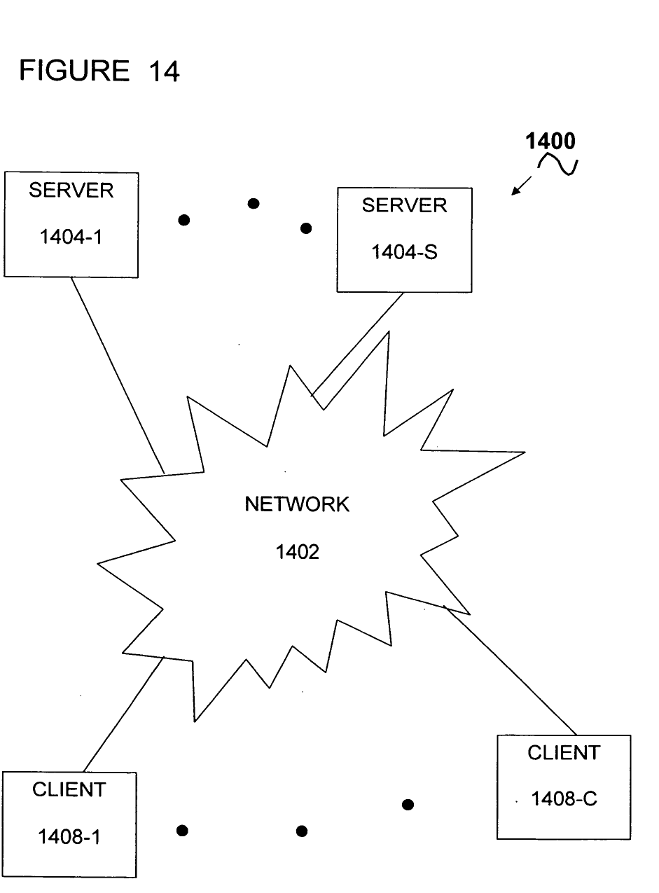

FIG. 3A depicts, generally at 300, an arrangement of structures used within an interactive training environment, according to one embodiment of the invention. With reference to FIG. 3A, the arrangement of structures is indicative of the elements of the graphical user interface used to provide the interactive training environment. A patient history is indicated at 302, and described as above provides the relevant medical background leading up to the present moment for the living being. A user, operating the graphical user interface, selects an actor from the group of actors 304; the selection is indicated at 306. The user selects at 310 one or more instruments from a group of instruments indicated by 308. A view of the patient “living being” is provided within a window 312 of a graphical user interface on an information display. The information display is part of an information processing system and is described more fully below in conjunction with FIG. 13 and FIG. 14. Within window 312 the user participates in the medical procedure by playing a role of the actor selected at 306. Feedback is returned at 314 and is provided to the user so that the user's knowledge of the medical procedure is improved.

Accordingly, embodiments of the invention are utilized to provide medical students or new physicians with an environment in which the user can “fail,” during a simulation of a medical procedure, without imparting life threatening consequences to a live patient.

FIG. 3B illustrates, generally at 330, a main screen of a graphical user interface according to one embodiment of the invention. With reference to FIG. 3B, a window of a graphical user interface is indicated at 332. A heading 334 shows the medical procedures that are available within the embodiment of the invention depicted. A procedure titled “Modified Pelvic Lymph Node Dissection” is indicated at 336 and will be illustrated below within the figures that follow.

A “Patient History” is accessed by selecting field 338 within the window 332. Teaching on the medical procedure is accessed by selecting field 340 which provides an introduction to the medical procedure by one or more subject matter experts. Additional teaching pertaining to the medical procedure is provided by the subject matter expert as concluding remarks in an “afterward” which is accessed by selecting field 350.

The medical procedure is partitioned into parts as previously described. Video of an actual medical procedure for each of the component parts is accessed by selection of one of the files in 354. In one embodiment, a user's knowledge of the medical procedure is tested by selecting field 360. In one embodiment, a practice mode is accessed by selecting field 358. Feedback on the user's performance is communicated via field 356.

FIG. 3C illustrates, generally at 360, a patient history according to one embodiment of the invention. With reference to FIG. 3C, a window 362 of a graphical user interface, displays a region 370 where a patient history is displayed. In other embodiments, additional information pertaining to the patient history includes but is not limited to laboratory studies, imaging, and pathology, as well as the indications and contraindications of the procedure to be performed. Audio files are contained in the patient history and can come from recorded audio messages created by the doctors that rendered medical care to the patient right up to the present moment.

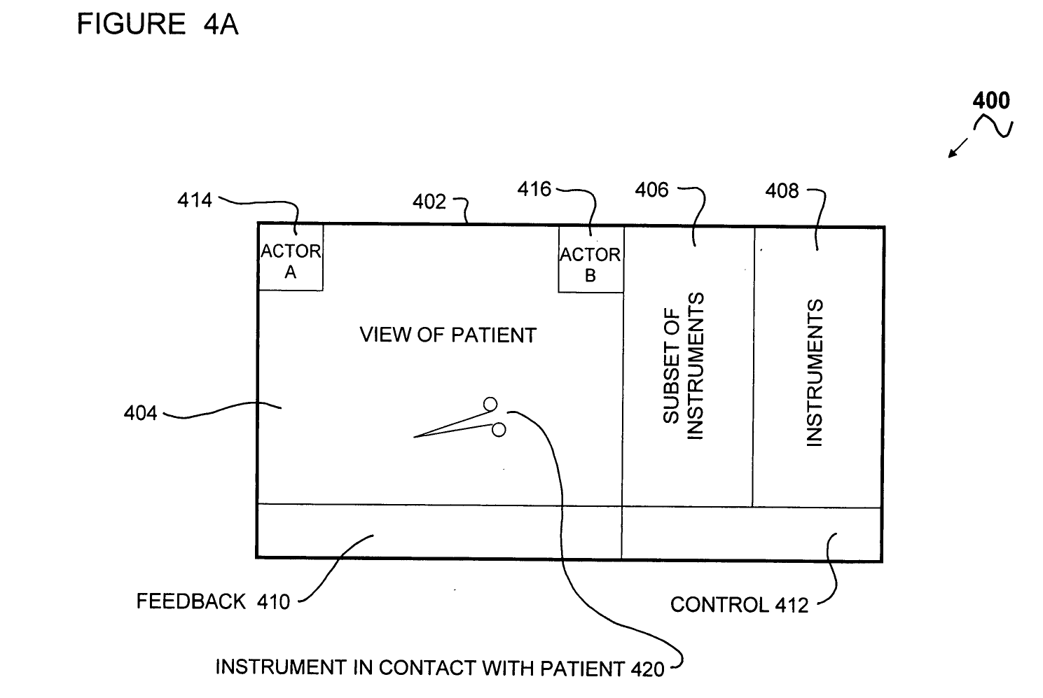

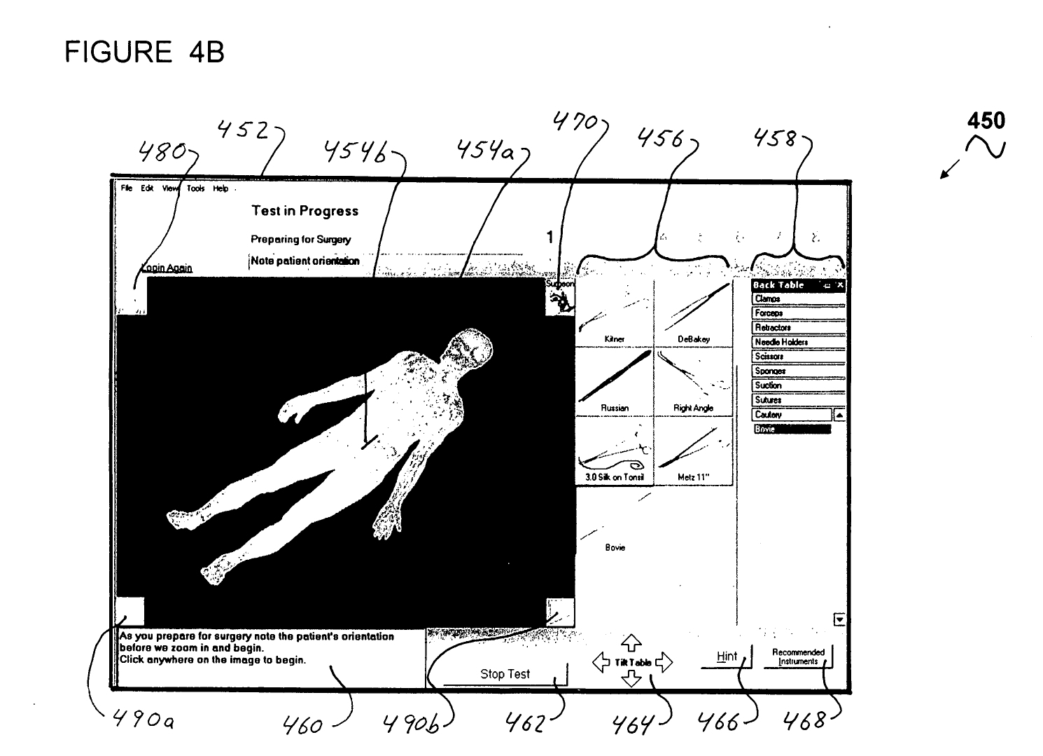

FIG. 4A depicts, generally at 400, a graphical user interface according to one embodiment of the invention. With reference to FIG. 4A, a window of a graphical user interface is indicated at 402. The window 402 includes a first region 404 where a view of the living being is displayed. A second region 408, of the window 402, represents a location within an operating room where medical instruments are stored. A third region 406 of the window 402 provides a location for a subset of medical instruments. A first actor is designated at 414 and a second actor is designated at 416. Feedback to the user is presented at location 410 and control of the graphical user interface is provided at 412. An instrument in contact with a patient is indicated at 420.

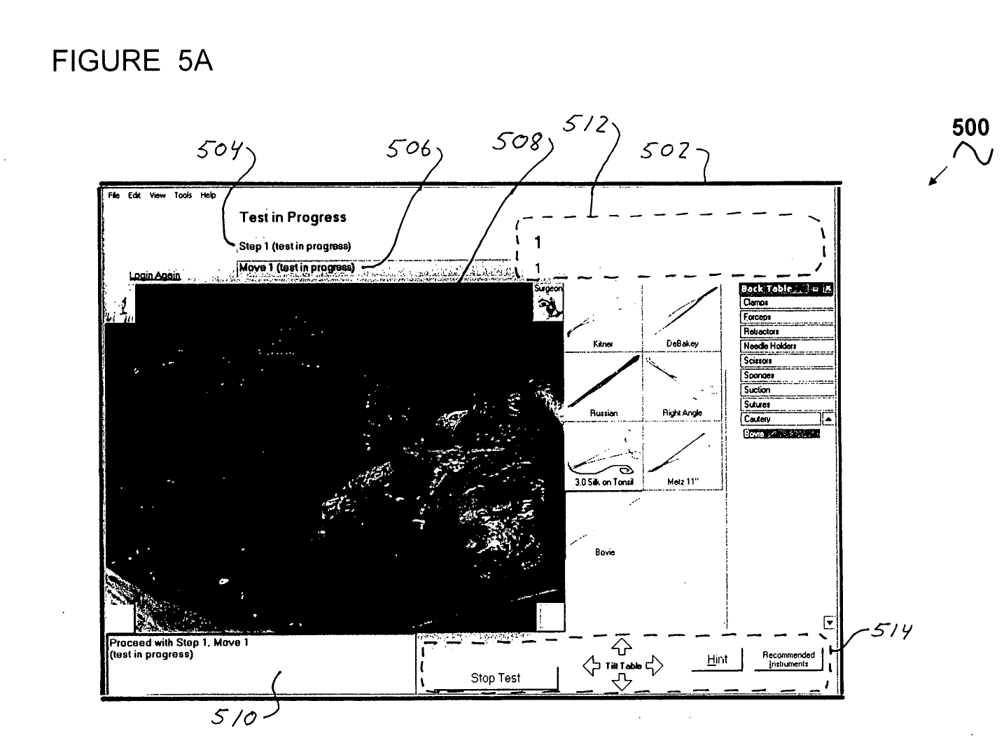

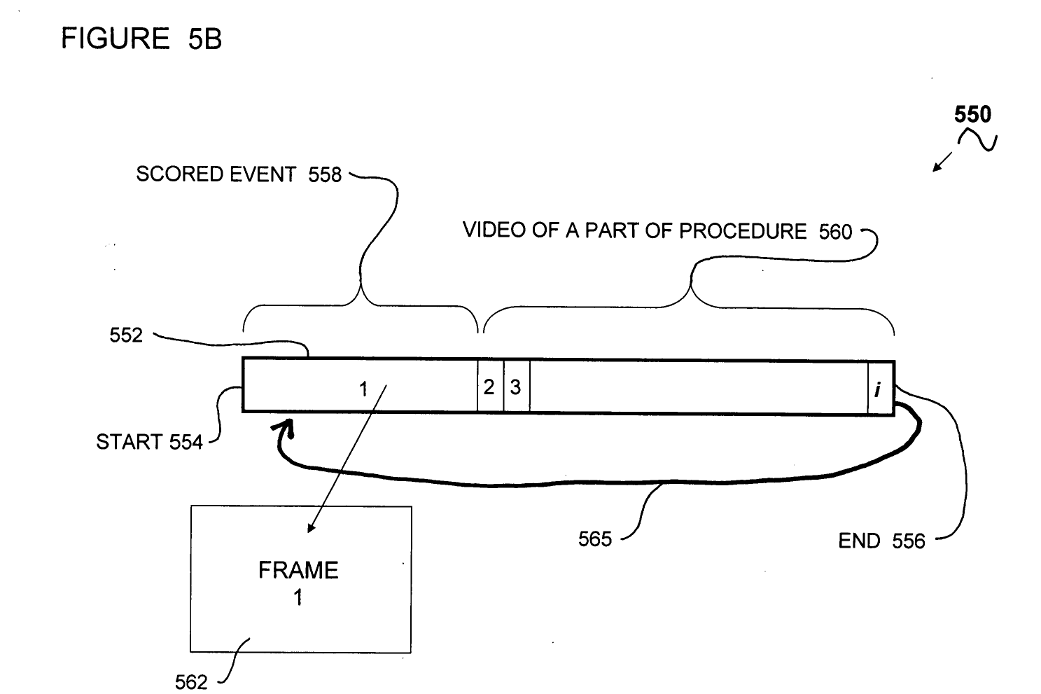

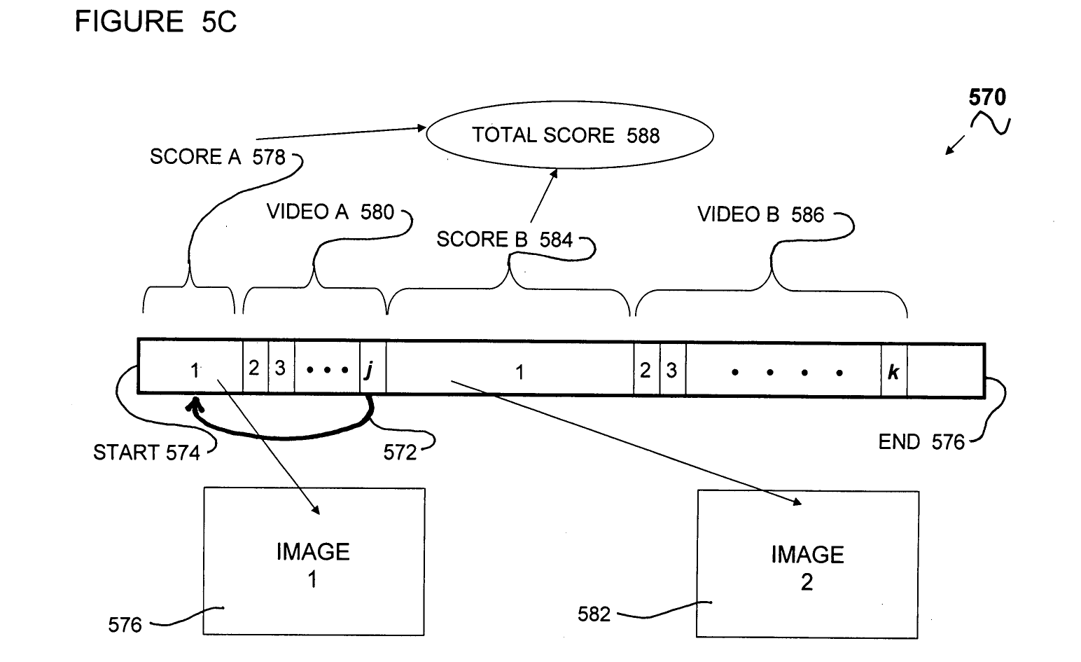

Locations, such as 410 and 412 can be rearranged or supplemented by additional locations, on the graphical user interface, that provide feedback and control functionality. For example, with reference to FIG. 5A, feedback is provided at 504 and 506 in addition to 510. Similarly, control is provided at a location 512 and a location 514. The location 512 permits a user to change a current part of the medical procedure that is available to the user. Referring back to FIG. 4A, many other arrangements of the graphical user interface are possible and embodiments of the invention are not limited to the arrangement shown in FIG. 4A or to the arrangements shown in the other figures of this description.

The first actor 414 and the second actor 416 are portions of the window 402 that designate the actors that participate during a medical procedure. In some embodiments, only one actor is present. In other embodiments, more actors (two, three, four, etc.) can be inserted as the complexity of the procedure dictates. In one embodiment, such portions of the window 402 are active fields, such as buttons, represented by icons. The icons can have indicia such as a text label, an image of a surgeon or an image of an assistant associated therewith to convey to the user the type of actor represented thereby.

In one embodiment, the second region 408 represents a “back table” of an operating room, where a wide variety of medical instruments are kept. As part of the interaction, during the execution of the medical procedure, a user selects instruments from the second region 408 and locates the instruments in the third region 406. In one embodiment, the second region 406 represents a “Mayo stand.” The Mayo stand, as is known to those of skill in the art, is the stand that is proximate to the table supporting the patient. Interaction by the user proceeds, as would occur with an actual medical procedure, with an actor selecting instruments from the second region 408 (back table) to place in the third region 406 (Mayo stand).

The user playing the role of an actor performs acts which produce results that are associated with events that occur during an actual medical procedure. In one example, a user playing the role of the actor “assistant” has the assistant select an instrument “a Kitner” from the third region 406 and points to a location on the image of the living being presented in the first region 404, simulating an instrument in contact with the patient at 420. A medical procedure can be executed by a user playing the role of a single actor such as a surgeon or the user can play the role of the surgeon and the assistant by alternating between the two actors during the course of the simulation of the medical procedure within the interactive medical procedure training environment. In one embodiment, multiple users perform a medical procedure in concert with each other, where each user plays a respective role of an actor using the graphical user interface. For example, one user plays the role of the surgeon and one user plays the role of an assistant. Those of skill in the art will recognize that any number of actors can participate in a medical procedure and embodiments of the invention are readily adapted to accommodate a plurality of actors. In some embodiment, multiple surgeons are present as well as multiple assistants, embodiments of the invention are not limited by the number of actors selected to participate in the medical procedure. Utilizing a network and a plurality of data processing devices, multiple users can work in concert with each other during a medical procedure simulation. In one embodiment, their views of the anatomy can be adjusted depending on their role and where they are located in the operating room. Such an embodiment permits users in different locations to “practice a medical procedure” without being co-located.

In one embodiment, feedback is provided to the user at the location 410, such as informing the user that the instrument was placed at the proper location on the patient 420. In another embodiment, the user can request a hint and the hint is communicated as feedback 410. As described above, feedback can take a variety of forms. In one or more embodiments, feedback is provided by an audio message to the user. Providing audio feedback to the user allows the user to keep his or her eyes on the view of the patient 404, without having to read text at location 410.

Control of the interactive medical procedure is indicated at control 412. Control 412 represents, in various embodiments, control of the orientation of the patient on a table, a field with which to request a hint, a field with which to request an array of recommended instruments, controls to stop a test or to select a mode without a test.

FIG. 4B illustrates, generally at 450, a preoperative screen according to an embodiment of the invention. With reference to FIG. 4B, a window 452 of a graphical user interface contains a skeletal representation 454a of a living being in a first region of the window 452. Such an initial skeletal view is presented to orient a user; thereby indicating a location 454b for the medical procedure on the living being. As described above, a “Modified Pelvic Lymph Node Dissection” procedure is described herein. The location 454b identifies the location of the incision for the pelvic lymph node dissection (PLND) in terms of human anatomy to assist the orientation of the user.

A second region 458, of the window 452, provides storage of medical instruments representing a “Back Table” of an operating room. Active fields labeled, “Clamps,” “Forceps,” etc. represent locations on an information display that open sub-windows to indicate the types of clamps, forceps, etc. stored therein. A third region 456, of the window 452, represents those medical instruments selected by the user for use during the current medical procedure. In one or more embodiments, digital images of actual medical instruments are displayed in the third region 456 and the first region of the window 452 to provide a realistic look and feel for a user.

Field 470 represents an icon indicating that the current actor is the surgeon. The field 470 is active, whereas a field 480 is inactive. Activation of the field 470 indicates that the surgeon is the actor that should be performing the current part of the medical procedure. In one embodiment, a subsequent part of the medical procedure requires the assistant to become the actor; in such a case, one embodiment of the invention is configured to require the user to activate the field 480 (causing the field 470 to become inactive). Another embodiment of the invention changes the active field automatically, as one part of the medical procedure is completed and the next part requires an action by a different actor.

In one embodiment, the control field 412 (FIG. 4A) contains controls as indicated in FIG. 4B, such as a field 462 to stop a test, controls 464 to tilt the table (changes the orientation of the patient), a field 466 to request a hint, and a field 468 to see an assortment of recommended instruments load into the third region 456 of the window 452. Controls can be located in other portions of the window 452, as indicated by 490a and 490b. The fields 490a and 490b permit a user to advance the medical procedure to the next part or to return to a previous part. Instructions to the user are provided at 460 to facilitate use and operation of the interactive medical procedure training environment. Feedback to the user based on a user's action or lack thereof is also provided at 460.

FIG. 5A illustrates, generally at 500, a part of a medical procedure according to one embodiment of the invention. With reference to FIG. 5A, a window 502, of a graphical user interface, contains a digital image 508 of an open area of a living being's anatomy. In the embodiment of FIG. 5A, the open area is a view presented to a surgeon when executing the “Modified Pelvic Lymph Node Dissection.” As described above, a medical procedure can be divided into a series of steps and moves, where a medical procedure such as the “Modified Pelvic Lymph Node Dissection” is made up of a series of steps and each step has one or more moves associated therewith. Fields within the window 502 provide feedback to a user and indicate the particular place within the medical procedure that the digital image 508 represents, such as Step 1 at 504 and Move 1 at 506. Controls 512 permit the user to select a different step or move of the medical procedure. Instructions to the user are presented at 510. Other communications are directed to the user at this stage of the medical procedure, such as an instruction to the user, that in Step 1, the user rotates the patient. The user can request a hint, and feedback can be presented at 510 that informs the user to use the table control to rotate the patient away from the surgeon. Rotating the patient is accomplished with the controls such as 464 (FIG. 4B).

FIG. 5B is a schematic illustrating, generally at 550, a part of a medical procedure according to one embodiment of the invention. With reference to FIG. 5B, a sequence of images that makes up a full motion video segment is indicated at 552. The sequence of images has a first frame or beginning, indicated by 554 and a last frame or end indicated by end 556. The sequence of images is displayed in the graphical user interface as described above, at for example, 404 (FIG. 4A), 508 (FIG. 5A), etc. Image 562 represents a first frame or substantially a first frame of a series of frames of a video sequence that was taken previously during an actual medical procedure or a computer aided simulation of an actual medical procedure. Such a sequence of images can be, in various embodiments, a video sequence recorded with an analog video camera, a digital video camera, a stereoscopic video recording or a computer animation.

In one embodiment, image 562 persists within the window 502 (FIG. 5A) so that a user can perform a required part of the medical procedure. In one embodiment, an action by the user produces a result, which is processed to produce a scored event 558. A length of the full motion video segment 552 indicates a play time of the sequence. In one embodiment, a user is tested as the user performs the part of the medical procedure, such testing can produce the result which is processed to produce the scored event 558. The length of time that image 562 is displayed is used as part of the scoring that is performed by the system while the user is being tested on the part of the medical procedure.

Video of a part of the medical procedure is indicated at 560, where images 2 through a general number i are played in sequence to provide a full motion video of the medical procedure the user is participating in. The architecture described above, where the user is exposed to the first frame of a video sequence that corresponds to a part of the medical procedure and then experiences the medical procedure as the video segment is played, reinforces the actual medical procedure in the user's mind. Those of skill in the art will recognize that variations are possible while still capturing the effect described herein. For example, the same effect can be achieved by starting the video close to image 562, while not exactly on image 562. The start point of the video can be made to occur at a variety of different points relative to image 562 so that the user is presented with the appearance of a relatively smooth transition from image 562 to the video portion 560.

In another embodiment, the video starts with image 562 and proceeds to frame i at end 556, without the pause on image 562. Such smooth motions can occur for all of the parts of a medical procedure such that the result presented to the user is a continuous video of the medical procedure.

In another embodiment, an image persists within a window, such as the window 502 (FIG. 5A) for a user to interact with during a part of an interactive medical procedure simulation. A video segment can play in the window to demonstrate the proper performance of part of the medical procedure and in one or more embodiments the image is not part of the video segment, but instead the image is chosen to closely resemble the start of the video segment so that a smooth transition is presented to the user.

In another embodiment, a practice loop 565 permits the user to repeat the portion of the medical procedure again by returning to image 562 to perform the interactive portion of the medical procedure or to view the video sequence once again staring with image 562.

FIG. 5C is a schematic illustrating, generally at 570, a series of user interactions according to one embodiment of the invention. With reference to FIG. 5C, a sequence of video images that are displayed within a graphical user interface is indicated by start 574 and end 576. Such a sequence of images represents a plurality of parts of a medical procedure, such as steps within a medical procedure or moves within a step of a medical procedure.

Within a general point of a medical procedure, such as step n, move m, a user sees image 576 displayed on the graphical user interface. The user performs an action generating a result while observing image 576 on the information display. After the user finishes the interaction, a video segment, indicated by video A 580 plays on the information display. The resulting action taken by the user and associated “result A” is processed by the system to produce a score indicated by score A 578. Successive interaction by the user occurs with the next part of the medical procedure, such as step n, move m+1, which displays image 582 for the user. Following action taken by the user, in response to image 582, a video B 586 plays, which demonstrates to the user how that portion of the medical procedure should be performed. Action taken by the user, based on image 582, produces a “result B” that is processed by the system to create a score indicated by score B 584. The score A 578 and the score B 584 are aggregated at 588 to provide a total score 588.

Any number of steps and moves can be assembled together as illustrated in FIG. 5C to provide a continuous experience in which the user experiences the entire medical procedure in an interactive way. Alternatively, the user can choose to repeat a portion of the medical procedure by initiating a practice loop 572. Such a practice loop permits the user to repeat a portion of the medical procedure such as step x, move y, or to view again the video that accompanies the portion of the medical procedure. When an error or critical event occurs, the user will have to respond appropriately. In one embodiment, graphic animation of error sequelae may be superimposed over video to create an effect.

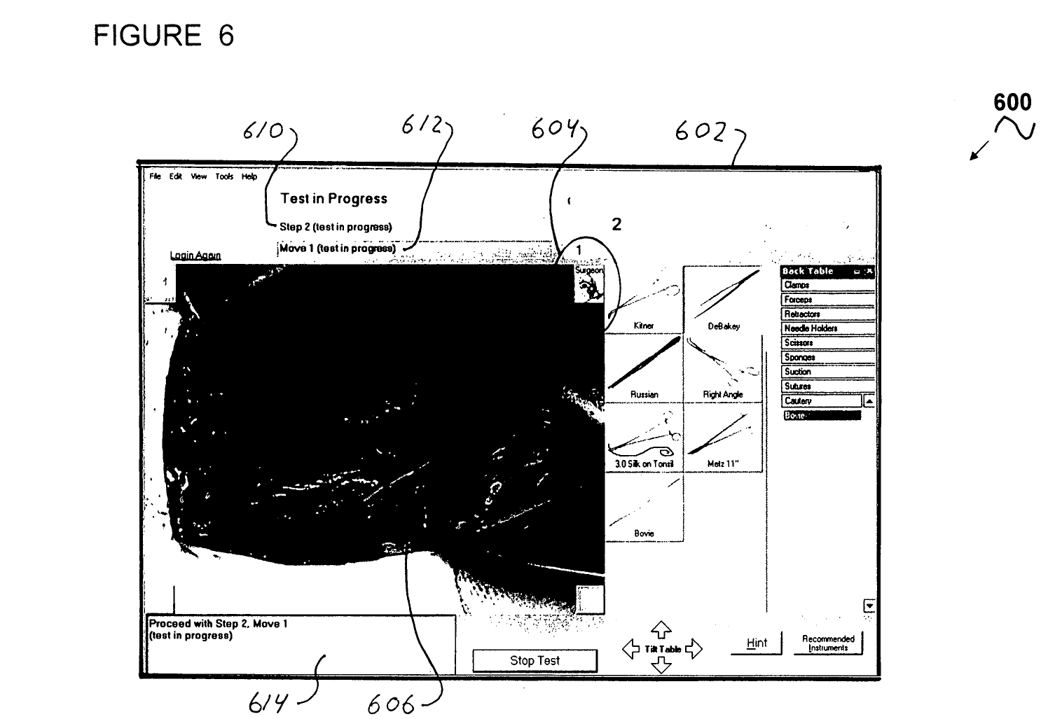

FIG. 6 illustrates, generally at 600, an association of an actor and a medical instrument according to one embodiment of the invention. With reference to FIG. 6, a window 602 displays an interactive environment, in which a user experiences a simulation of a medical procedure. A user plays the role of an actor, such as a surgeon as indicated at 604. Using various pointing devices (mouse, stylus and touch pad, etc.) or voice recognition techniques, the user selects a medical instrument such as forceps 606. In one embodiment, the association between the medical instrument and the actor is accomplished by tilting the medical instrument in the direction of the active actor, surgeon 604 in this example. In another embodiment, the association between the tool and the actor is accomplished by activating an icon that represents the actor. In FIG. 6, the surgeon icon is activated while the assistant icon is not. In one or more embodiments, such activation is accomplished by highlighting the active icon and dimming the inactive icon.

Either the system or a user can activate an icon. In one or more embodiments the system selects an actor. The icon representing the selected actor can be highlighted by the system. In another embodiment, an instrument is tilted toward the icon representing the selected actor. In another embodiment both can occur. In one or more embodiments, the user selects the actor. The user can select the actor with various pointing devices or by voice command. The icon representing the selected actor can be highlighted in response to actions taken by the user (selection with a pointing device, voice command, etc.). In another embodiment, an instrument is tilted toward the icon representing the selected actor. In another embodiment both can occur. Other ways of activating an icon are blinking the active icon by the system, etc. In light of these teachings, those of skill in the art will recognize other ways of calling attention to one icon in lieu of another icon. All such techniques are within the scope contemplated by embodiments of the invention.

In one embodiment, the view presented using the image of the anatomy shown in FIG. 6 corresponds with Step 2 (610), Move 1 (612) of the “Modified Pelvic Lymph Node Dissection” medical procedure, as indicated at 614. Within Step 2, the lymphatic tissue is split. Move 1 requires the tissue to be lifted to protect the iliac vein. A user can request a hint from the system. A hint returned, in response to a request from the user, tells the user that the surgeon should lift the lymph tissue opposite (inferior-radial aspect) with the DeBakey forceps. If another medical instrument can be used, in various embodiments, the hint will so instruct the user.

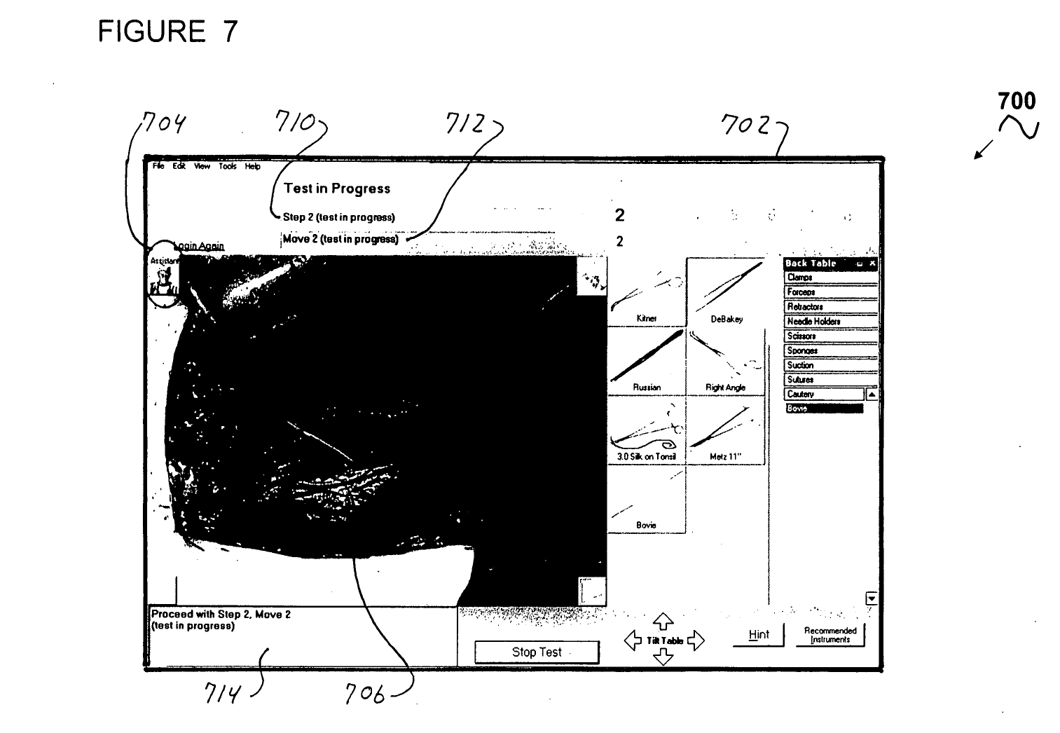

FIG. 7 illustrates, generally at 700, another association of an actor and an instrument according to one embodiment of the invention. With reference to FIG. 7, a window 702 displays an interactive environment, in which a user experiences a simulation of a medical procedure. A user plays the role of an actor, such as an assistant as indicated at 704. Using various pointing devices or voice recognition techniques, the user selects a medical instrument such as forceps 706. In one embodiment, the association between the medical instrument and the actor is accomplished by tilting the medical instrument in the direction of the active actor, assistant 704 in this example. In another embodiment, the association between the tool and the actor is accomplished by activating an icon that represents the actor. In FIG. 7, the surgeon icon is activated while the assistant icon is not. Such activation is accomplished as is known to those of skill in the art by highlighting the active icon and dimming the inactive icon or by other techniques so designed to call attention to one icon in lieu of another icon.

In one embodiment, the view presented using the image of the anatomy shown in FIG. 7 corresponds with Step 2 (710), Move 2 (712) of the “Modified Pelvic Lymph Node Dissection” medical procedure, as indicated at 714. Move 2 requires the tissue to be lifted to protect the iliac vein. A user can request a hint from the system. A hint returned, in response to a request from the user, tells the user that the assistant should use the DeBakey forceps and that the lymph tissue on the superior medial aspect of the iliac vein must be lifted above the vein in preparation for cauterizing it. If another medical instrument can be used or if a different actor could perform the action, in various embodiments, the hint will so instruct the user.

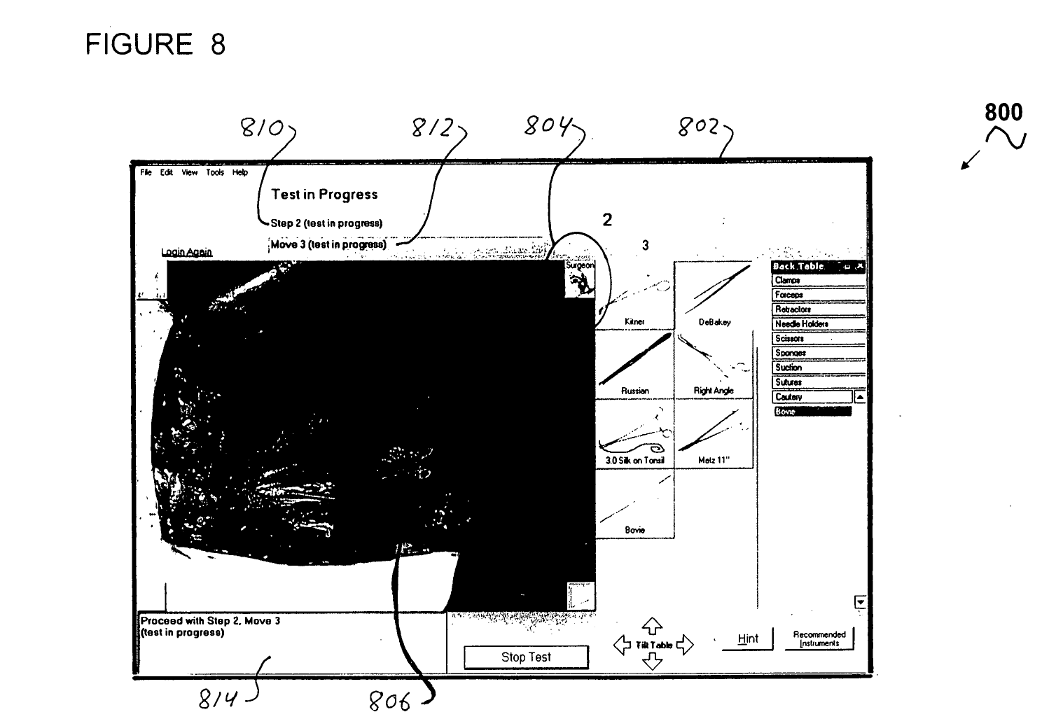

FIG. 8 shows, generally at 802, a test of a user action according to one embodiment of the invention. With reference to FIG. 8, a user, playing the role of an actor, such as the surgeon 804, is manipulating a medical instrument such as 806 over the image of the living being. The location of the pointing device is represented on the image of the living being by an image of the medical instrument the user has selected. The manipulation can be directed to using the instrument 806 to indicate where the tissue should be cut. In various embodiments, the user will use a pointing device to produce a result which indicates a location within the image of the living being. The system will process the result as described previously. The processed result can be the basis of feedback that is provided to the user. Alternatively, or in addition to feedback, the processed result can be the basis of a score that is registered and compiled for the user during the simulation of the medical procedure.

In one embodiment, the view presented using the image of the anatomy shown in FIG. 8 corresponds with Step 2 (810), Move 3 (812) of the “Modified Pelvic Lymph Node Dissection” medical procedure, as indicated at 814. Move 3 requires the tissue to be pulled taut in preparation for cutting. A user can request a hint from the system. A hint returned, in response to a request from the user, tells the user that the surgeon should insert the medium sized right angled forceps between the vein and lymph tissue and spread the tines, pulling the lymph tissue taut. If another medical instrument can be used or if a different actor could perform the action, in various embodiments, the hint will so instruct the user.

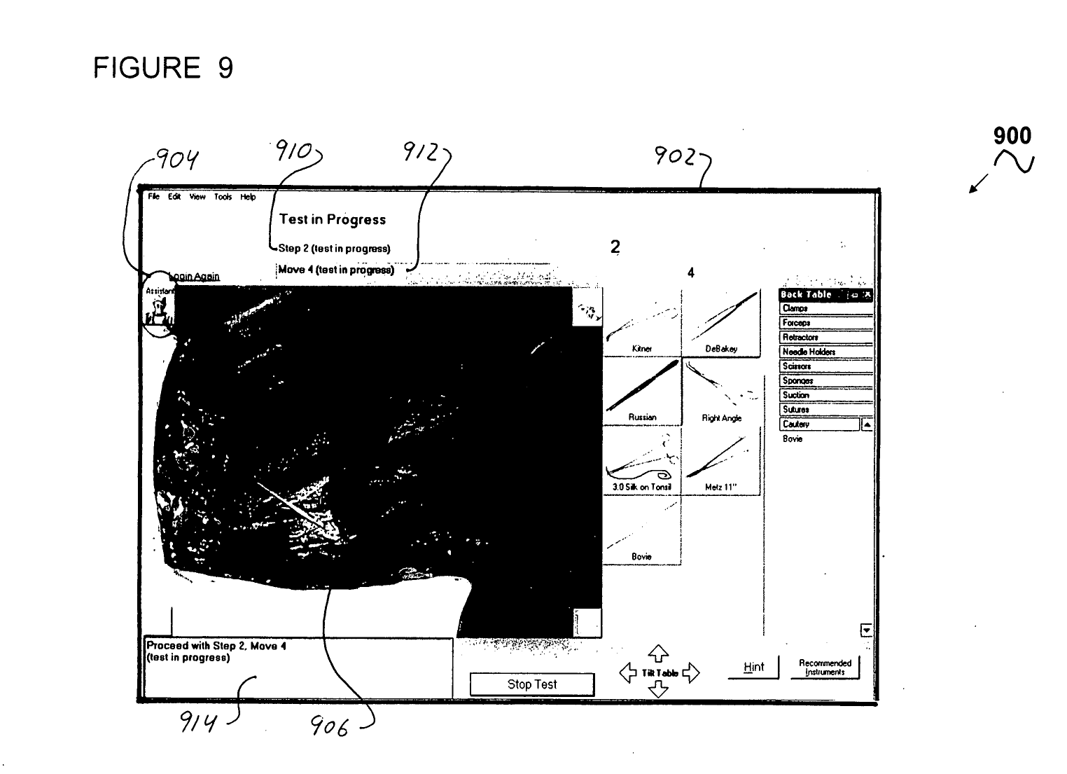

FIG. 9 shows, generally at 900, another test of a user action according to one embodiment of the invention. With reference to FIG. 9, a user, playing the role of an actor, such as the assistant 904 manipulates a medical instrument 906 within the image of the living being. The manipulation can be directed to using the instrument 906 to indicate where the tissue should be held taught (in one embodiment). In various embodiments, the user will use a pointing device to produce a result which indicates a location within the image of the living being. The system will process the result as described previously. The processed result can be the basis of feedback that is provided to the user. Alternatively, or in addition to feedback, the processed result can be the basis of a score that is registered and compiled for the user during the simulation of the medical procedure.

In one embodiment, the view presented using the image of the anatomy shown in FIG. 9 corresponds with step 2 (910), move 4 (912) of the “Modified Pelvic Lymph Node Dissection” medical procedure, as indicated at 914. Move 4 notifies the user that the lymph tissue above the vein is ready to be cut. A user can request a hint from the system. A hint returned, in response to a request from the user, tells the assistant should use the Bovie cauterizer to cauterize the tissue between the tines and right angle forceps. The assistant may also use the Metzenbaum scissors.

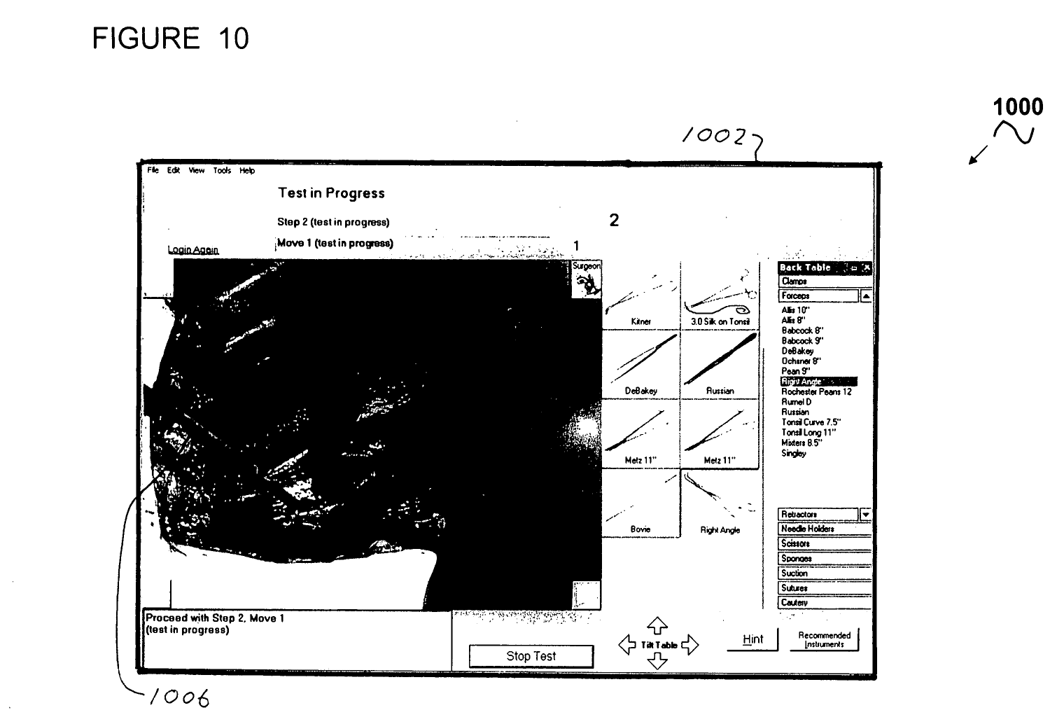

FIG. 10 illustrates, generally at 1000, a frame of a video sequence according to one embodiment of the invention. With respect to FIG. 10, a video sequence plays within a window 1002 of the graphical user interface. The first frame of the video sequence is illustrated on FIG. 10 where the Bovie cauterizer 1006 is shown cutting the tissue while the assistant and the surgeon position the tissue for cutting. In one or more embodiments, a user can watch a video sequence or a complete video after completing a step, a move, etc.

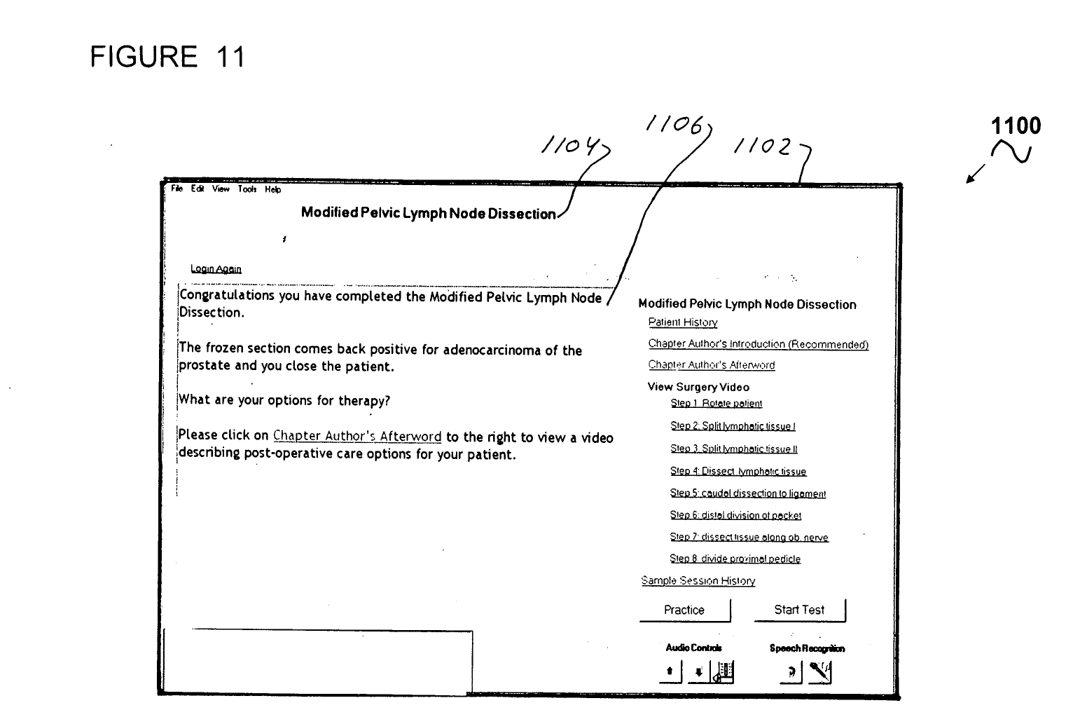

FIG. 11 illustrates, generally at 1100, an example of feedback provided to a user following an interactive training session, according to one embodiment of the invention. With reference to FIG. 11, a window of an interactive training environment 1102 displays the title of the medical procedure at 1104 and some concluding feedback and instruction to a user at 1106.

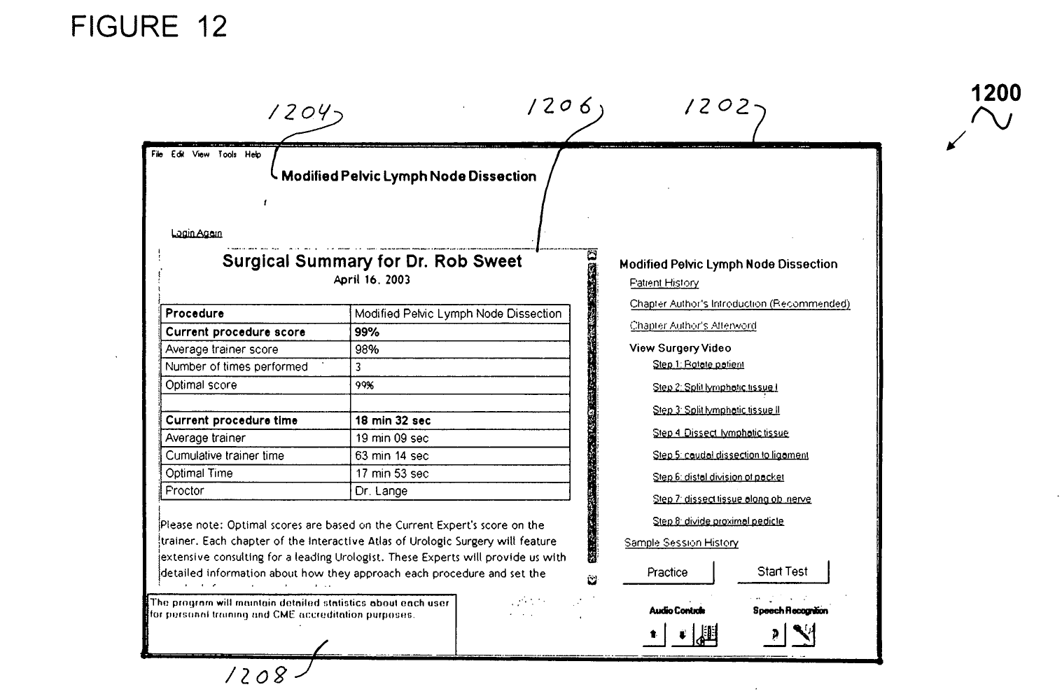

FIG. 12 illustrates, generally at 1200, an example of score information provided to a user according to one embodiment of the invention. With reference to FIG. 12, a window 1202 of an interactive training environment displays the title of the medical procedure at 1204, statistics, and other score information pertaining to the user at 1206. Score information is reported in a variety of forms according to embodiments of the invention. For example, at 1206 an overall score is shown as “Current procedure score 99%.” In this embodiment, the user's score is compared against an optimal score of 99% as well as an average score, computed from the users who have used the interactive training environment for the medical procedure shown at 1204.

Score information can be processed and output to meet different criteria. For example, in one embodiment, the interactive training environment is used to provide a continuing medical education (CME) tool that physicians use to satisfy their annual requirement for CME credits where the “criterion levels” for performance are established based on subject-matter expert (SME) data. Such a use is described below in conjunction with FIG. 13 and FIG. 14.

Any aspect of the user's interaction with the medical procedure can be evaluated with embodiments of the invention. For example, some user actions that can be tested are, but are not limited to, selection of instruments; identification of the correct location on a living being; identification of the correct path on a living being; selection of the correct actor; patient orientation; time taken for a move, step, etc.; number of hints requested, patient diagnosis (preoperative indications for surgery and the contraindications for surgery); identification of anatomy, etc. In various embodiments, the nature of the errors performed are sorted and organized to aid the user in understanding areas to focus on for improvement based on these criteria.

FIG. 13 illustrates, generally at 1300, a block diagram of a computer system (data processing device) in which embodiments of the invention may be used. The block diagram is a high level conceptual representation and may be implemented in a variety of ways and by various architectures. Bus system 1302 interconnects a Central Processing Unit (CPU) 1304, Read Only Memory (ROM) 1306, Random Access Memory (RAM) 1308, storage 1310, display 1320, audio, 1322, keyboard 1324, pointer 1326, miscellaneous input/output (I/O) devices 1328, and communications 1330. The bus system 1302 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 1304 may be a single, multiple, or even a distributed computing resource. Storage 1310 may be Compact Disc (CD), Digital Versatile Disk (DVD), hard disks (HD), optical disks, tape, flash, memory sticks, video recorders, etc. Display 1320 might be, for example, an embodiment of the present invention. Note that depending upon the actual implementation of a computer system, the computer system may include some, all, more, or a rearrangement of components in the block diagram. For example, a thin client (FIG. 14) might consist of a wireless hand held device that lacks, for example, a traditional keyboard. Thus, many variations on the system of FIG. 13 are possible.

Thus, in various embodiments, the interactive training environment is implemented with a data processing device incorporating components as illustrated in FIG. 13. In various embodiments, a pointing device such as a stylus is used in conjunction with a touch screen, for example, via 1329 and 1328 to allow a user to define an area on an image of a living being. Connection with a network is obtained with 1332 via 1330, as is recognized by those of skill in the art, which enables the data processing device 1300 to communicate with other data processing devices in remote locations.

FIG. 14 illustrates, generally at 1400, a network environment in which embodiments of the present invention may be implemented. The network environment 1400 has a network 1402 that connects S servers 1404-1 through 1404-S, and C clients 1408-1 through 1408-C. As shown, several data processing devices (computer systems) in the form of S servers 1404-1 through 1404-S and C clients 1408-1 through 1408-C are connected to each other via a network 1402, which may be, for example, a corporate based network. Note that alternatively the network 1402 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc. Thus, the invention may find application at both the S servers 1404-1 through 1404-S, and C clients 1408-1 through 1408-C.

In one embodiment, a continuing medical education (CME) course incorporating the interactive training environment described herein is available to users on C clients 1408-1 through 1408-C. One or more servers 1404-1 through 1404-S interact with the C clients while the users are taking the CME course. In one embodiment, scoring and reporting of the performance of the users is done by one or more servers S; thereby providing a format in which users can take CME courses and the accrediting body can be sure that the users actually have performed the required study, etc. required by the accrediting body.

In another embodiment, a new medical procedure is developed at a teaching hospital or research facility that is remotely located from at least some number of clients C. Users located in remote areas with access to a client C can learn the new medical procedure in the interactive training environment described in embodiments herein; thereby, permitting the users in remote locations to learn the new medical procedure without needing to travel. Utilizing the techniques taught herein, a new medical procedure is disseminated quickly throughout the medical community.

In another embodiment, new physicians, such as interns, can use embodiments of the invention to gain familiarity with medical procedures before entering the operating room to observe an actual medical procedure.

In another embodiment, users in a battlefield environment can use embodiments of the invention to become familiar with medial procedures that they might not have encountered previously or that they have encountered infrequently; thereby, refreshing themselves on the medical procedure before actually administering the medical procedure to a live patient.

In various embodiments, a debit or a credit is exchanged for use of an interactive medical procedure training environment by a user, an organization, etc. For example, in one embodiment a debit or a credit is exchanged for use of a medical procedure training environment (graphical user interface, etc.). In another embodiment, a debit or a credit is exchanged for feedback provided to a user. In another embodiment, a debit or a credit is exchanged for a score. In another embodiment, a debit or a credit is exchanged for a CME credit, etc.

The uses of embodiments described herein are only a sampling of the uses that embodiments of the invention admit. Those of skill in the art will recognize other uses of embodiments of the invention that facilitate allowing users to simulate a medical procedure; all such other uses are within the scope of the teaching presented herein.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods herein may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. Thus, the description does not limit the scope of the invention, as the scope of the invention is defined only by the appended claims.

What is claimed is:

1. A method comprising:
selecting an actor to participate in an interactive simulation of a medical procedure within a graphical user interface;
identifying a medical instrument to be used by the actor; and
indicating an association between the medical instrument and the actor, wherein a user plays the role of the actor.

2. The method of claim 1, wherein the association is accomplished by tilting the medical instrument in the direction of the actor.

3. The method of claim 1, wherein the association is accomplished by activating an icon.

4. The method of claim 1, wherein the association is accomplished with a pointing device or by voice recognition.

5. The method of claim 1, wherein the actor performs the role of a surgeon or an assistant during the medical procedure.

6. The method of claim 1, wherein the assistant is an assistant surgeon, a nurse, or a person that participates during the medical procedure.

7. The method of claim 1, wherein the medical procedure is further comprised of a plurality of parts.

8. The method of claim 7, wherein the user interacts with the graphical user interface during a first part of the medical procedure to produce a result.

9. The method of claim 8, wherein the result is a selection of an actor, a grouping of medical instruments, a selection of a medical instrument, a placement of a medical instrument on a living being, marking a region on the living being, marking a location on the living being, answering a question or requesting a hint.

10. The method of claim 9, wherein the living being is a human or an animal.

11. The method of claim 1, wherein the selecting is accomplished by voice recognition or with a pointing device.

12. A method comprising:
creating within a window of a graphical user interface on an information display a first region where a digital image of a living being is displayed;
creating within the window a second region where medical instruments are located;
providing within the window a third region where selected medical instruments are arranged; and
identifying an actor to perform a part of a medical procedure within the graphical user interface, wherein a user can play the role of the actor by interacting with the graphical user interface wherein the user performs an action.

13. The method of claim 12, further comprising:
associating the actor with a medical instrument.

14. The method of claim 13, wherein the associating is accomplished by tilting the medical instrument in the direction of the actor.

15. The method of claim 13, wherein the associating is accomplished by activating an icon.

16. The method of claim 13, wherein the associating is accomplished with a pointing device or by voice recognition.

17. The method of claim 12, further comprising:
registering a result, wherein the result is based on an input from the user.

18. The method of claim 17, wherein the input from the user is obtained by a method selected from the group consisting of voice recognition and utilizing a pointing device.

19. The method of claim 17, wherein the input from the user is obtained with a touch screen and a stylus.

20. The method of claim 17, further comprising:
generating a score based on the result.

21. The method of claim 17, further comprising:
providing feedback to the user based on the result.

22. The method of claim 21, wherein feedback is in the form of a text message, a written statement, an audio message or a video message.

23. The method of claim 21, wherein feedback is a score, a hint, a description of a medical procedure, a description of a part of a medical procedure, notice of an error, notice of a correct action, a video of a part of a medical procedure or an operational instruction.

24. The method of claim 20, further comprising;
exchanging a debit or a credit for the score.

25. The method of claim 12, further comprising:
testing the user's action.

26. The method of claim 25, wherein the user's action tested is selection of the actor, instruments chosen for the operating stand, orientation of the living being, instrument chosen for a part of the medical procedure, identification of a location on the living being, identification of a path on the living being, time taken to execute a part of the medical procedure, number of hints requested, diagnosis of the living being or identification of the living being's anatomy.

27. The method of claim 25, further comprising:
providing feedback to the user based on the testing.

28. The method of claim 27, wherein feedback is in the form of a text message, a written statement, an audio message or a video message.

29. The method of claim 27, wherein feedback to the user is a score, a hint, a description of a medical procedure, a description of a part of a medical procedure, notice of an error, notice of a correct action, a video of a part of a medical procedure or an operational instruction.

30. The method of claim 27, further comprising;
exchanging a debit or a credit for the feedback.

31. The method of claim 12, wherein the digital image is recorded from a medical procedure performed on a living being.

32. The method of claim 12, wherein the digital image is a video segment or a single digital image.

33. The method of claim 12, wherein the digital image is a stereoscopic image.

34. The method of claim 32, wherein substantially a first frame of the video segment is displayed in the first region when the user performs a part of the medical procedure.

35. The method of claim 12, wherein the digital image resembles a beginning of a video segment that runs in the first region.

36. The method of claim 12, wherein a first frame of the video segment is displayed in the first region when the user performs a part of the medical procedure.

37. The method of claim 12, wherein the medical procedure is an open surgery, an endoscopic surgery, a laparoscopic surgery, a microsurgery, a Seldinger technique, an extra corporeal procedure, an emergency medical procedure or an invasive interaction with a living being.

38. The method of claim 12, wherein the living being is a human or an animal.

39. The method of claim 12, wherein the identifying is accomplished by voice recognition or with a pointing device.

40. An apparatus comprising:
an information display;
a window capable of being displayed on the information display, the window having a first region, a second region, a third region, and an actor identifier;
a digital image of a living being to be displayed in the first region;
a set of medical instruments to be displayed in the third region;
a subset of medical instruments to be displayed in the second region, wherein a user can play the role of an actor and perform an action during a part of a medical procedure simulated on the information display.

41. The apparatus of claim 40, wherein the actor can be associated with a medical instrument.

42. The apparatus of claim 41, wherein an association between the actor and the medical instrument is accomplished by tilting the medical instrument in the direction of the actor.

43. The apparatus of claim 41, wherein an association between the actor and the medical instrument is accomplished by activating an icon.

44. The apparatus of claim 41, wherein an association between the actor and the medical instrument is accomplished with a pointing device or by voice recognition.

45. The apparatus of claim 40, wherein an input from the user causes a result to be registered.

46. The apparatus of claim 45, wherein the input from the user is obtained by a method selected from the group consisting of voice recognition and utilizing a pointing device.

47. The apparatus of claim 45, wherein the input from the user is obtained with a touch screen and a stylus.

48. The apparatus of claim 45, wherein a score is to be generated based on the result.

49. The apparatus of claim 45, wherein feedback is to be provided to the user based on the result.

50. The apparatus of claim 49, wherein feedback is in the form of a text message, a written statement, an audio message or a video message.

51. The apparatus of claim 49, wherein feedback is a score, a hint, a description of a medical procedure, a description of a part of a medical procedure, notice of an error, notice of a correct action, a video of a part of a medical procedure or an operational instruction.

52. The apparatus of claim 48, wherein a debit or a credit is exchanged for the score.

53. The apparatus of claim 40, wherein the user's action can be tested.

54. The apparatus of claim 53, wherein the user's action is selection of the actor, instruments chosen for the operating stand, orientation of the living being, instrument chosen for a part of the medical procedure, identification of a location on the living being, identification of a path on the living being, time taken to execute a part of the medical procedure, number of hints requested, diagnosis of the living being or identification of the living being's anatomy.

55. The apparatus of claim 54, wherein the living being is a human or an animal.

56. The apparatus of claim 53, wherein feedback to the user can be provided based on the testing.

57. The apparatus of claim 56, wherein feedback is in the form of a text message, a written statement, an audio message or a video message.

58. The apparatus of claim 56, wherein feedback to the user is a score, a hint, a description of a medical procedure, a description of a part of a medical procedure, notice of an error, notice of a correct action, a video of a part of a medical procedure or an operational instruction.

59. The apparatus of claim 56, wherein a debit or a credit is exchanged for the feedback.

60. The apparatus of claim 40, wherein the digital image is recorded from a medical procedure performed on a living being.

61. The apparatus of claim 40, wherein the digital image is a video segment or a single digital image.

62. The apparatus of claim 40, wherein the digital image is a stereoscopic image.

63. The apparatus of claim 61, wherein substantially a first frame of the video segment is displayed in the first region when the user performs a part of the medical procedure.

64. The apparatus of claim 40, wherein the digital image resembles a beginning of a video segment that runs in the first region.

65. The apparatus of claim 40, wherein a first frame of the video segment is displayed in the first region when the user performs a part of the medical procedure.

66. The apparatus of claim 40, wherein the medical procedure is an open surgery, an endoscopic surgery, a laparoscopic surgery, a microsurgery, a Seldinger technique, an extra corporeal procedure or a microsurgery.

67. An apparatus comprising:
a first data processing device;
a network capable of being coupled to the first data processing device;
a second data processing device having an information display, the second data processing device capable of being coupled to the network and capable of being in communication with the first data processing device; and
a computer readable medium containing executable computer program instructions, which when executed by a data processing system, cause the data processing system to perform a method comprising:
creating within a window on the information display a first region where a digital image of a living being is displayed;
creating within the window a second region where medical instruments are located;
providing within the window a third region where selected medical instruments are arranged; and
identifying an actor to perform a part of a medical procedure, wherein a user can play the role of the actor and perform an action.

68. The apparatus of claim 67, wherein the actor can be associated with a medical instrument.

69. The apparatus of claim 68, wherein an association between the actor and the medical instrument is accomplished by tilting the medical instrument in the direction of the actor.

70. The apparatus of claim 68, wherein an association between the actor and the medical instrument is accomplished by activating an icon.

71. The apparatus of claim 68, wherein an association between the actor and the medical instrument is accomplished with a pointing device or by voice recognition.

72. The apparatus of claim 67, wherein the action can be tested.

73. The apparatus of claim 72, wherein the action is selection of the actor, instruments chosen for the operating stand, orientation of the living being, instrument chosen for a part of the medical procedure, identification of a location on the living being, identification of a path on the living being, time taken to execute a part of the medical procedure, number of hints requested, diagnosis of the living being or identification of the living being's anatomy.

74. The apparatus of claim 73, wherein the action is associated with a continuing medical education course.

75. The apparatus of claim 74, wherein a debit or a credit is exchanged for the testing the action.

76. The apparatus of claim 74, wherein the medical procedure is an open surgery, an endoscopic surgery, a laparoscopic surgery, a microsurgery, a Seldinger technique, an extra corporeal procedure, an emergency medical procedure or an invasive interaction with a living being.

77. The apparatus of claim 67, wherein the living being is a human or an animal.

78. A computer readable medium containing executable computer program instructions, which when executed by a data processing system, cause the data processing system to perform a method comprising:
creating within a window a first region where a digital image of a living being is displayed;
creating within the window a second region where medical instruments are located;
providing within the window a third region where selected medical instruments are arranged; and
identifying an actor to perform a part of a medical procedure, wherein a user can play the role of the actor.

79. The computer readable medium of claim 78, wherein the living being is a human or an animal.

80. An apparatus comprising:
means for displaying a medical procedure on an information display;
means for associating a user with an actor, wherein the actor represents a participant in the medical procedure;
means for allowing the-user to perform a part of the medical procedure; and
means for associating a medical instrument with the actor.

81. The apparatus of claim 80, further comprising:
means for registering a result based on input from the user.

82. The apparatus of claim 81, further comprising:
means for generating a score based on the result.

83. The apparatus of claim 80, further comprising:
means for providing feedback to the user.
